(19) United States
(12) Patent Application Publication
(10) Pub. No.: US 2004/0008571 A1
(43) Pub. Date: Jan. 15, 2004

(54) Apparatus and method for accelerating hydration of particulate polymer

(76) Inventors: Richard L. Coody, Skiatook, OK (US); Marc A. Chalmers, Tulsa, OK (US)

Correspondence Address: Crowe & Dunlevy, Suite 1800, 20 North Broadway, Oklahoma City, OK, 73102-8273, US

(21) Appl. No.: 10/618,384

(22) Filed: Jul. 11, 2003

Related U.S. Application Data
(60) Provisional application No. 60/395,084, filed on Jul. 11, 2002.

(51) Int. Cl. B01F 15/02

(52) U.S. Cl. 366/154.1; 366/163.1; 366/168.1

(57) ABSTRACT

Disclosed is an apparatus and method for hydrating particulate polymer. In the presently preferred embodiment, the apparatus includes a storage assembly, a hydration assembly and a delivery assembly that connects the storage assembly to the hydration assembly. The hydration assembly preferably includes a pre-wetter, a high-energy mixer and a blender. The preferred method for hydrating the particulate polymer includes transferring the polymer from the storage assembly to the hydration assembly. The method further includes pre-wetting the particulate polymer with a hydration fluid to form a gel, mixing the gel with additional hydration fluid in a high-energy mixer and blending the gel in a blender. The method may also include removing any air entrained in the gel in a weir tank.

### RELATED APPLICATIONS

This application claims the benefit of U.S. Provisional Patent Application No. 60/395,084 filed Jul. 11, 2002, which is herein incorporated by reference.

FIELD OF THE INVENTION

The present invention generally relates to the preparation of substances useable as well treatment fluids. More particularly, the present invention relates to the accelerated hydration of a polymer gel agent. Once hydrated, the polymer gel can be combined with suitable particulate matter (“proppant”) or other chemicals to yield well treatment fluids. Well treatment fluids are commonly used in fracturing, acidizing, completion and other wellbore operations.

### BACKGROUND OF THE INVENTION

High viscosity water based well treatment fluids, such as fracturing fluids, acidizing fluids, and high density completion fluids, are commonly used in the oil industry in treating oil and gas wells. These fluids are normally made by suspending proppant material with a carrier gel at the well site. Typically, the carrier gel is produced using dry polymer additives or agents, which are mixed with water or other fluids at the well site or at a remote location.

The mixing procedures used in the past have inherent problems. The earliest batch mixing procedures involved mixing sacks of the polymer in tanks at the job site. This method produced inaccurate mixing and lumping of the powder into insoluble “gel balls” or “fisheyes” which obstructed the flow of the gel and generated chemical dust hazards.

To achieve better mixing, it is known to delay hydration long enough for the individual polymer particles to disperse and become surrounded by water so that no dry particles are trapped inside a gelled coating to form a gel ball. This delay can be achieved by coating the polymer with material such as borate salts, glyoxal, non-lumping HEC, sulfosuccinate, metallic soaps, surfactants, or other materials of opposite surface charge to the polymer. Another known way to improve the efficiency of polymer addition to water and derive the maximum yield from the polymer is to prepare a stabilized polymer slurry (“SPS”), also referred to as a liquid gel concentrate (“LGC”). The liquid gel concentrate is premixed and then later added to the water.

Although aqueous-based liquid gel concentrates have worked well at eliminating gel balls, aqueous concentrates can suspend only a limited quantity of polymer due to the physical swelling and viscosification that occurs in a water-based medium. Typically, about 0.8 pounds of polymer can be suspended per gallon of the concentrate. By using a hydrocarbon carrier fluid, rather than water, higher quantities of solids can be suspended. Hydrocarbon-based liquid gel concentrates can be later mixed with water in a manner similar to that for aqueous-based liquid gel concentrates.

In environmentally sensitive locations, however, governmental regulations restrict the use of hydrocarbon-based liquid gel concentrates. There are numerous environmental problems associated with the clean-up and disposal of both hydrocarbon-based concentrates and well treatment gels containing hydrocarbons; as well as with the cleanup of the tanks, piping, and other handling equipment which have been contaminated by the hydrocarbon-based gel.

In addition to prior art homogenization and capacity limitations, transporting premixed liquid gel concentrate in bulk to offshore and remote locations is cost prohibitive. Service vehicles utilized to supply offshore and remote locations have a limited storage capacity and are often forced to make multiple trips between the production facility and the remote location, particularly when the liquid gel concentrate is water-based.

Because it is easier and more cost effective to transport the polymer and hydrating fluid separately it is desirable to continuously mix a well treatment gel “on-the-fly” during the actual treatment of the subterranean formation from dry ingredients. Such online systems could satisfy the fluid flow requirements for large hydraulic fracturing jobs during the actual fracturing of the subterranean formation by continuously mixing the fracturing gel.

One method and apparatus for continuously mixing a fracturing gel is disclosed in U.S. Pat. No. 4,828,034 to Constien et al., in which a fracturing fluid slurry concentrate is mixed through a static mixer device on a real time basis with a hydrocarbon-based solvent, such as diesel. The slurry is then pushed through baffled tanks in a first-in, first-out flow pattern to produce a hydrated fracturing fluid during the actual fracturing operation. Because hydrocarbon-based fluids are used to prepare the gel, this technology has limited application under modern regulatory programs.

U.S. Pat. No. 5,190,374 to Harms et al., discloses a method and apparatus for continuously producing a carrier gel, by feeding dry polymer into an axial flow mixer which uses a convergent fluid mixing energy to wet the polymer during its initial contact with water. During use, however, the dry polymer splatters tends to stick to the walls of the mixer, accumulate and eventually choke the flow through the mixer.

Accordingly, there is a need for a process to produce a carrier gel in which relatively higher amounts of polymer per unit volume can be utilized while eliminating the environmental problems and objections related to hydrocarbon-based concentrates. There is also a need for apparatus and method for producing carrier gels on a substantially continuous basis during the well treatment operation to alleviate the problems of storing and transporting pre-mixed carrier gels.

### SUMMARY OF THE INVENTION

The present invention includes an apparatus and method for hydrating particulate polymer. In the presently preferred embodiment, the apparatus includes a delivery assembly that connects a storage assembly to a hydration assembly. The hydration assembly preferably includes a pre-wetter, a high-energy mixer and a blender.

The preferred method for hydrating the particulate polymer includes transferring the polymer from the storage assembly to the hydration assembly. The method further includes pre-wetting the particulate polymer with a hydration fluid to form a gel, mixing the gel with additional hydration fluid in a high-energy mixer and blending the gel in a blender. The method may also include removing any air entrained in the gel in a weir tank.

### BRIEF DESCRIPTION OF THE DRAWINGS

FIG. 1 is a side elevational view of an apparatus capable of hydrating particulate polymer constructed in accordance with a presently preferred embodiment of the present invention.

FIG. 2 is a side elevational view of a preferred embodiment of the hydration assembly of the apparatus of claim 1.

FIG. 3 is a side view of an alternate embodiment of the mixer of FIG. 2.

FIG. 4 is a flowchart of a preferred method for hydrating particular polymer.

### DETAILED DESCRIPTION OF THE PREFERRED EMBODIMENT

As disclosed herein, a carrier gel (“gel”) is prepared through the combination of a substantially dry polymer and a hydration fluid, such as water. The gel can be subsequently diluted or blended with proppant material or chemicals to produce a well treatment fluid. Although the present invention is not so limited, a particularly suitable polymer is disclosed in U.S. patent application Ser. No. 10/146,326, filed by White. As used herein, the term “particulate” broadly designates solids capable of movement through augers or similar devices and includes solids otherwise referred to as “granular,” “pulverized,” “powder” or by related terms. Although the term “polymer” typically refers to synthetic materials, as used herein, the term “polymer” also includes naturally occurring materials, such as guars and gums

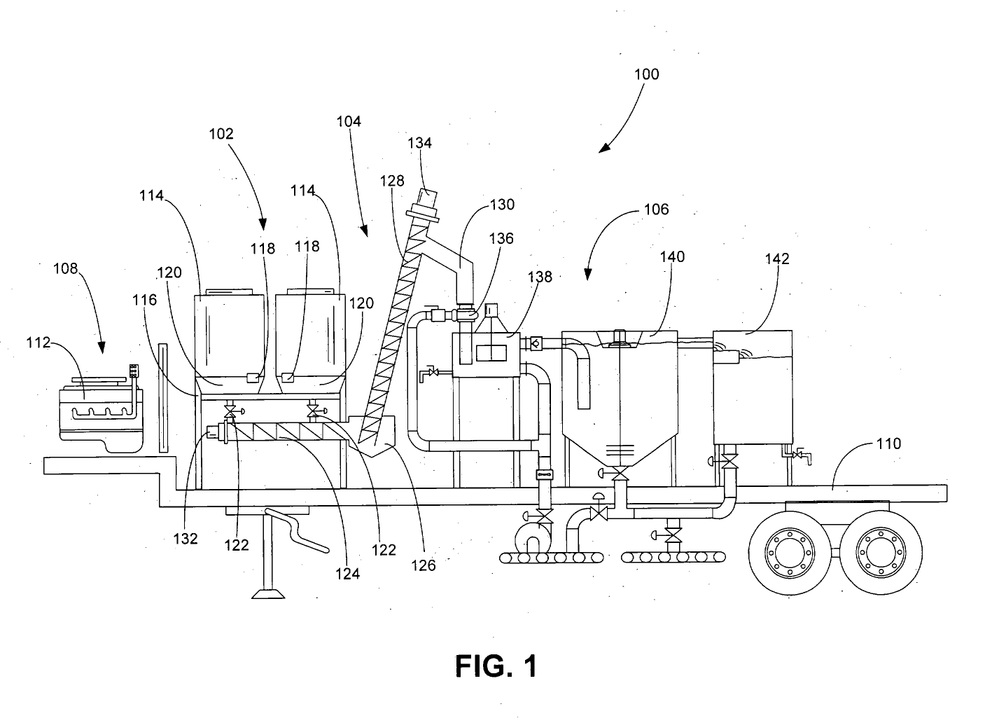

Referring first to FIG. 1, shown therein is a side elevational view of a hydration apparatus 100 constructed in accordance with a preferred embodiment of the present invention for preparing a carrier gel from a substantially dry particulate polymer and a hydrating fluid. The hydration apparatus 100 preferably includes a polymer storage assembly 102, a delivery assembly 104, a hydration assembly 106 and a power assembly 108. In the preferred embodiment, a trailer 110 supports the storage, delivery, hydration and power assemblies 102, 104, 106 and 108, respectively. The trailer 110 is configured for attachment to common trucks or semi-tractors. It will be understood that each of the separate components of the apparatus 100 could also be supported by other fixed or mobile structures, such as skids, boats or concrete pads.

The power assembly 108 preferably includes an engine 112 that directly or indirectly drives one or more hydraulic pumps, electric generators and pneumatic compressors (not shown). In the preferred embodiment, the hydraulic pumps, electric generators and pneumatic compressors are used to provide power to the various other components within the apparatus 100. The construction of power systems for service equipment is well known in the art.

The storage assembly 102 is configured to contain substantially dry polymer prior to hydration. In the presently preferred embodiment, the storage assembly 102 includes a plurality of removable tote tanks 114 and a receiving rack 116 configured to support the tote tanks 114. In the preferred embodiment, the receiving rack 116 is designed to receive the legs on each of the tote tanks 114 and is equipped with double locking pins. The receiving rack 116 preferably includes one or more pneumatic vibrators 118 that generate gentle harmonics that aid the flow of the dry polymer from the tote tanks 114.

Each tote tank 114 preferably includes an anti-bridging discharge cone 120 equipped with a shut-off knife valve 122. The operation of the knife valves 120 control the flow of dry particulate polymer from each tote tank 114. In a particularly preferred embodiment, the storage assembly 102 includes four tote tanks 114, each with separate discharge cones 118, shut-off valves 122 and pneumatic vibrators 118.

During use of the apparatus 100, one or more of the tote tanks 114 can be simultaneously used to supply the necessary dry polymer. In this way, empty tote tanks 114 can be advantageously replaced with full tote tanks 114 without interrupting a continuous delivery of polymer to the hydration assembly 106. Furthermore, unlike conventional bulk polymer storage designs, the tote tanks 114 can be substantially sealed to prevent the hydrophilic polymer from prematurely hydrating with ambient moisture.

The delivery system 104 preferably includes a metering auger 124, a collection chamber 126, a transfer auger 128, a discharge chamber 130 and related controls (not shown). In the presently preferred embodiment, gravity moves the dry particulate polymer from the tote tanks 114 to the metering auger 124. Each of the components in the delivery system 104 is preferably sealed to reduce the exposure of the dry polymer to ambient or environmental moisture. Although not shown in FIG. 1, an additional intermediate sealed hopper can be used to connect the discharge cones 118 with the metering auger 124 to increase the flow of polymer from the tote tanks 114 and further prevent the introduction of ambient moisture to the system.

The metering auger 124 moves the particulate polymer at a selected volumetric rate from the tote tanks 114 to the collection chamber 126. The polymer is then moved from the collection chamber 126 to the hydration assembly 106 with the transfer auger 128. The collection chamber 126 is preferably equipped with a 45° angled inlet and provides an area for the transfer of material from the metering auger 124 to the transfer auger 128. In the preferred embodiment, the transfer auger 128 is flexible to permit bending from the 45° inlet of the collection chamber 126 to a nearly vertical position. In this way, polymer is carried up the transfer auger 128 from the collection chamber 126 to the discharge chamber 130. The discharge chamber 130 provides a sealed conduit between the delivery assembly 104 and the hydration unit 106.

In the presently preferred embodiment, the metering auger 124 and transfer auger 128 include high-torque hydraulic motors 132 and 134, respectively, that are controlled electronically over hydraulic proportional valves (not shown) with manual control valves as redundant backups (not shown). In the preferred embodiment, the proportional control valves receive a signal from a programmable logic circuit that is pre-programmed with the desired ratio of polymer to water. As such, the programmable logic circuit can automatically control the delivery rates of polymer to the hydration assembly 106 through the metering auger 124 and transfer auger 128 in response to the volumetric flowrate of water being drawn into the apparatus 100. This control system permits the apparatus 100 to be programmed to track the operational characteristics of downstream equipment, such as gel/proppant blenders and pumper units. It will be understood that these and other control systems for the apparatus 100 can be located in a control station on the trailer 110 or at a remote location.

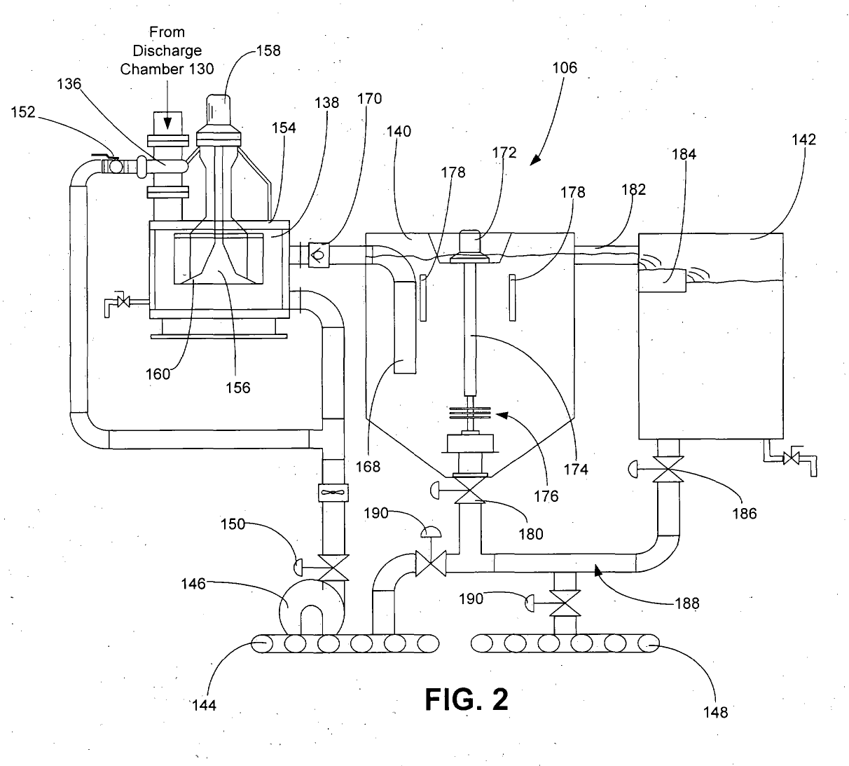

Turning next to FIG. 2, shown therein is a side elevational view of the hydration assembly 106. The hydration assembly 106 preferably includes a pre-wetter 136, a high-energy mixer 138, a blender 140 and a weir tank 142. The hydration assembly 106 further includes an intake manifold 144, at least one pump 146 and a discharge manifold 148.

In the presently preferred embodiment, the pump 146 is a mission-style centrifugal pump. The intake manifold 144 is preferably configured for connection with conventional fluid piping or hoses (not shown) to bring hydration fluid into the apparatus 100 from a hydration fluid source. The hydration assembly 106 further includes an intake valve 150 that manually or automatically controls the flow of pressurized hydration fluid from the pump 146 to the hydration assembly 106. High-pressure fluid supply lines (not numerically designated) connect the pump 146 to the pre-wetter 136 and high-energy mixer 138.

The pre-wetter 136 is preferably a venturi-cyclone type mixer in which high pressure hydration fluid creates a high-velocity, rapidly spinning funnel as it passes through the pre-wetter 136. To achieve the cyclonic flow pattern, high-pressure fluid is introduced at one side of the cylindrical pre-wetter 136. In the presently preferred embodiment, the pre-wetter 136 includes an internal “throat” that encourages the cyclonic flow pattern and accelerates fluids passing through the pre-wetter 136.

A pre-wetter valve 152 is used to adjust the flow of high-pressure fluid into the pre-wetter 136. The pre-wetter 136 is also connected to the discharge chamber 130 of the delivery assembly 104. In this way, dry polymer moves into the pre-wetter 136 where it initially contacts the high-pressure hydration fluid to form gel. The converging geometry of the cyclonic flow pattern, axial vortices and centrifugal forces in the pre-wetter 136 enhance the interfacial contact of the individual polymer particles.

The outlet of the pre-wetter 136 is connected to the high-energy mixer 138. The high-energy mixer 138 includes a closed housing 154, an impeller 156 and a motor 158. The impeller 156 is driven by the motor 158, which in turn is powered by pressurized hydraulic fluid. The impeller 156 includes a plurality of vanes 160 that are configured to transfer rotational energy and shearing action into the gel to further accelerate hydration and homogenize the consistency of the gel. In a particularly preferred embodiment, the vanes 160 include “cupped” surfaces that increase the transfer of energy to the gel. In an alternate embodiment, each of the vanes 160 includes one or more holes that augment the shearing action created by the impeller 156. The energy imparted to the gel by the high-energy mixer 138 is partially translated to velocity as the gel exits the high-energy mixer 138.

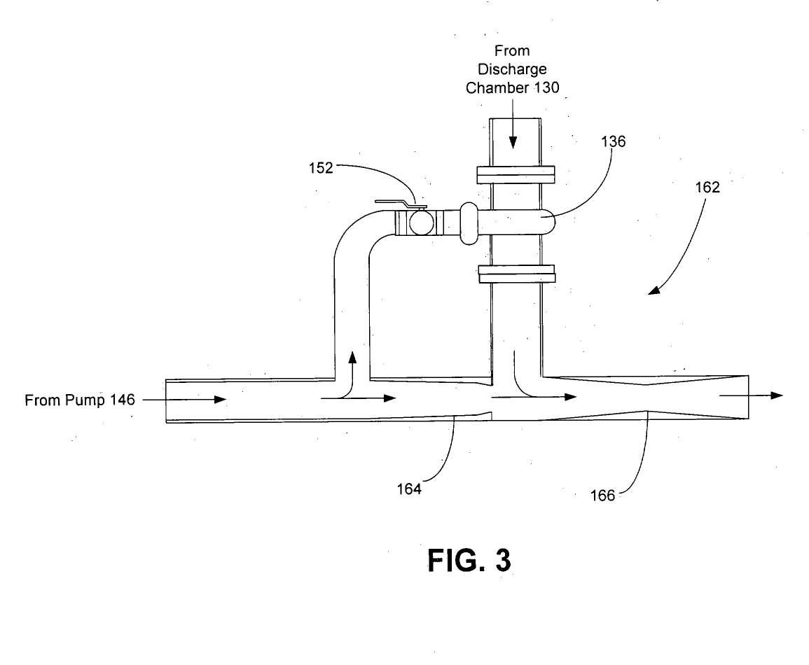

In an alternate embodiment, the high-energy mixer 138 is replaced or used in conjunction with an eductor mixer 162, shown in FIG. 3. As shown in FIG. 3, the eductor mixer 162 can be connected to the output of the pre-wetter 136 and to a high-pressure line from the pump 146. The eductor mixer 162 preferably includes one or more nozzles 164 and throats 166 to accelerate the pressurized hydration fluid. The acceleration of the hydration fluid lowers the pressure of the hydration fluid and draws the gel output of the pre-wetter 136 into the eductor mixer 162 for additional mixing and hydration. It will be noted that the eductor mixer 162 is particularly useful in lower volume hydration applications.

Turning back to FIG. 2, the blender 140 receives the accelerated gel output by the high-energy mixer 138. In the preferred embodiment, the blender 140 includes a discharge pipe 168 that introduces the gel from the high-energy mixer 138 below the surface of the gel contained in the blender 140. To prevent the potential backflow of gel from the blender 140 to the high-energy mixer 138, the hydration assembly 106 preferably includes a check valve 170.

The blender 140 preferably includes a motor 172, and one or more agitators that are driven by the motor 172 via a shaft 174. In the particularly preferred embodiment shown in FIG. 2, the agitators are three blender discs 176 that include holes in the top two discs and fins on the bottom of the lowest disc that collectively produce a smooth, rolling turbulence in the blender 140. The downward suction produced by the spinning blender discs 176 creates a vortex to and through the discs. Fins on the bottom of the blender discs force product off the tank bottom back up the sidewalls and into the downward suction vortex. Suitable discs are available from J. May Equipment Group of Arlington, TX under the MAXY-DISC trademark. Although blender discs 176 are presently preferred, the paddles, screws or propellers can also be employed alone or in combination with the preferred blender discs 176.

The blender 140 can also include one or more baffles 178 positioned at various positions that are configured to further refine the rolling turbulence created by the blender 140. The blender 140 also includes a drain valve 180 that can be used to drain the contents of the blender 140 to either the intake manifold 144 or discharge manifold 148.

The blender 140 includes an overflow conduit 182 that directs gel into the weir tank 142. Discounting changes in the density of the gel that occur within the blender 140, the same volumetric flowrate of gel entering the blender 140 exits the blender 140 to the weir tank 142 through the overflow conduit 182 during steady-state operation. Although the overflow conduit 182 is depicted near the top of the blender 140, it will be understood that the overflow conduit 182 could be positioned at different depths within the blender 140.

The weir tank 142 preferably contains one or more steps 184 that reduce the velocity of the gel and allow entrained air to escape. The weir tank 142 includes a drain 186 that can be used to deliver the gel to either the intake manifold 144 or the discharge manifold 148. In the preferred embodiment, the static head pressure created by the elevational difference between the weir tank 142 and the discharge manifold 148 is sufficient to feed gel to downstream storage facilities or equipment. In an alternate preferred embodiment, a second pump (not shown) can be used to deliver the gel from the weir tank 142 to downstream equipment.

The hydration assembly 106 includes discharge plumbing 188 and diverter valves 190 that connect the blender drain 174 and the weir tank drain 186 to the intake and discharge manifolds 144, 148. The diverter valves 190 can be used to divert output from the blender drain 174 and weir tank drain 186 to the discharge manifold 148 for delivery to downstream devices. It will be noted that, for some applications, it may not be necessary to use the weir tank 142. Additionally, the intake manifold 144 can alternatively be used to direct gel from the hydration assembly 106 to downstream equipment.

The diverter valves 190 can also be used to divert the output from the blender 140 and the weir tank 142 to the intake manifold 144 for recirculation within the hydration assembly 106. Recirculating the gel within the hydration assembly 106 can be used to adjust or maintain the consistency of the gel during the operation of apparatus 100.

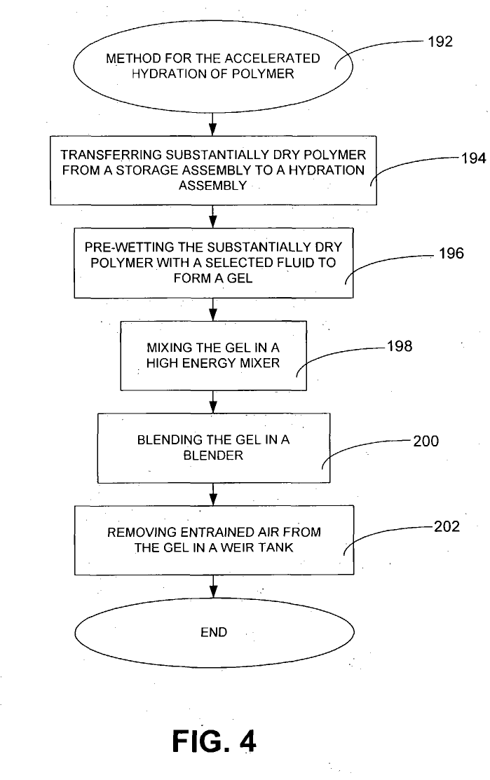

Turning now to FIG. 4, shown therein is a flowchart for a preferred method 192 for the accelerated hydration of polymer. Beginning at step 194, substantially dry polymer is transferred from the storage assembly 102 to the hydration assembly 106 with the delivery assembly 104. At step 196, the polymer is pre-wetted with a selected hydration fluid, preferably water, in the pre-wetter 136 to form a gel. Next, at step 198, the gel from the pre-wetter 136 is mixed and energized in the high-energy mixer 138. The gel is next blended in the blender 140 at step 200. Finally, at step 202, air entrained in the gel is removed in the weir tank 142. The order of the steps listed above in the preferred method 192 can be re-arranged to meet the needs of specific applications. Those skilled in the art will also recognize that one or more of the steps on the method 192 can be omitted without altering the successful hydration of particulate polymer as contemplated by the present invention.

It is to be understood that even though numerous characteristics and advantages of various embodiments of the present invention have been set forth in the foregoing description, appended claims and drawings, together with details of the structure and functions of various embodiments of the invention, this disclosure is illustrative only, and changes may be made in detail, especially in matters of structure and arrangement of parts within the principles of the present invention to the full extent indicated by the broad general meaning of the terms expressed above.

It is claimed:

1. A method for hydrating particulate polymer in a hydration apparatus, the method comprising:
transferring substantially dry particulate polymer from a storage assembly to a hydration unit;
pre-wetting the substantially dry particulate polymer with a hydration fluid in a pre-wetter to form a gel;
mixing the gel with additional hydration fluid in a high-energy mixer;
blending the gel in a blender; and
removing entrained air from the gel in a weir tank.

2. The method of claim 1; wherein the step of transferring substantially dry particulate polymer further comprises:
metering the particulate polymer from a tote tank to a collection chamber with a metering augur; and
transferring the particulate polymer from the collection chamber to a discharge chamber with a transfer auger.

3. The method of claim 2, wherein the metering auger and the transfer auger are automatically controlled in response to the amount of hydrating fluid being drawn into the apparatus.

4. The method of claim 1, wherein the step of pre-wetting the substantially dry particulate polymer further comprises:
inducing a cyclonic flow pattern of the hydration fluid in the pre-wetter; and
introducing the substantially dry particulate polymer into the hydration fluid having a cyclonic flow pattern.

5. The method of claim 1, wherein the step of mixing the gel further comprises imparting energy to the gel with an impeller inside the high-energy mixer.

6. The method of claim 1, wherein the step of mixing the gel further comprises:
introducing the gel into an eductor mixer; and
combining the gel with accelerated hydration fluid in the eductor mixer.

7. The method of claim 1, wherein the step of blending the gel further comprises producing a rolling turbulence in the gel with one or more agitators.

8. The method of claim 7, wherein the step of producing a rolling turbulence further comprises contacting the gel with one or more blender discs.

9. An apparatus for hydrating particulate polymer, the apparatus comprising:
a storage assembly;
a delivery assembly connected to the storage assembly; and
a hydration assembly connected to the delivery assembly, wherein the hydration unit comprises:
a pre-wetter;
a high-energy mixer; and
a blender.

10. The apparatus of claim 9, wherein the storage assembly further comprises:
at least one tote tank; and
a receiving rack configured to support the at least one tote tank.

11. The apparatus of claim 10, wherein the at least one tote tank further comprises:
an anti-bridging cone; and
a knife shut-off valve.

12. The apparatus of claim 10, wherein the receiving rack further comprises one or more pneumatic vibrators.

13. The apparatus of claim 9, wherein the delivery assembly further comprises:
a metering auger;
a collection chamber;
a transfer auger; and
a discharge chamber.

14. The apparatus of claim 13, wherein the transfer auger is flexible.

15. The apparatus of claim 9, wherein the pre-wetter is configured to induce a cyclonic flow pattern as hydration fluid enters the pre-wetter.

16. The apparatus of claim 9, wherein the high-energy mixer further comprises:
a housing; and
a rotating impeller.

17. The apparatus of claim 16, wherein the impeller includes a plurality of vanes that have cupped surfaces.

18. The apparatus of claim 16, wherein the impeller includes a plurality of vanes that include one or more holes.

19. The apparatus of claim 9, wherein the blender further comprises one or more blender discs that create a rolling turbulence when rotated in the presence of the gel.

20. The apparatus of claim 9, further comprising a weir tank having one or more steps.

21. The apparatus of claim 9, further comprising:
an intake manifold configured to draw hydration fluid into the apparatus;
a pump connected to the intake manifold; and
a discharge manifold configured to discharge gel to downstream equipment or storage facilities.

22. An apparatus for hydrating particulate polymer, the apparatus comprising:
a storage assembly, wherein the storage assembly includes one or more tote tanks supported by a receiving rack;
a delivery assembly connected to the storage assembly; and
a hydration assembly connected to the delivery assembly, wherein the hydration unit includes an eductor mixer.

23. An apparatus for hydrating particulate polymer, the apparatus comprising:
means for storing the particulate polymer;
means for hydrating the particulate polymer; and
means for delivering the particulate polymer from the means for storing the particulate polymer to the means for hydrating the particulate polymer.
